(19) United States
(12) Patent Application Publication
(10) Pub. No.: US 2003/0067153 A1
(43) Pub. Date: Apr. 10, 2003

(54) Restraint system for juvenile carriage

(76) Inventor: Stephen A. Stickel, Columbus, IN (US)

Correspondence Address: BARNES & THORNBURG, 11 SOUTH MERIDIAN, INDIANAPOLIS, IN, 46204

(21) Appl. No.: 09/973,652

(22) Filed: Oct. 9, 2001

(51) Int. Cl. B60R 22/00

(52) U.S. Cl. 280/801.1; 280/647

(57) ABSTRACT

A carriage for transporting at least one child includes a seat configured to support at least two side-by-side children, a plurality of wheels coupled to the seat, and a restraint system. The restraint system includes a lap belt and a first anchor. The lap belt is coupled to the seat at a first anchor location and a second anchor location. The first anchor is coupled to the seat at a third anchor location intermediate of the first anchor location and the second anchor location. The first anchor is configured to anchor the lap belt at the third anchor location.

### BACKGROUND AND SUMMARY OF THE INVENTION

The present invention relates to a carriage, and particularly to a carriage for transporting one or more children therein. More particularly, the present invention relates to a restraint system configured to restrain a child in the carriage.

Juvenile carriages, such as bicycle trailers and strollers, that are used to transport one or more children are known. Many conventional juvenile carriages include a restraint system to secure children in the carriage. Some conventional carriages can be configured to secure two, side-by-side children in one arrangement or a single child in another arrangement. When a single child is restrained in some conventional carriages that are configured to accommodate two side-by-side children, the single child sometimes shifts laterally in the carriage in an unwanted manner.

According to the present disclosure, a carriage comprises a seat, a plurality of wheels coupled to the seat, and a restraint system adapted to restrain a child in the seat. The restraint system includes a shoulder restraint coupled to the seat and adapted to lie across both shoulders of the child, a crotch strap coupled to the seat and arranged to be coupled to the shoulder restraint, and a lap belt coupled to the seat at a first anchor location and a second anchor location and adapted to lie across a lap of the child. The restraint system also includes a first anchor coupled to the seat at a third anchor location intermediate of the first anchor location and the second anchor location to anchor the lap belt at the third anchor location to restrict lateral movement of the child.

In illustrative embodiments, the restraint system further includes a second anchor coupled to the seat at a fourth anchor location to anchor the lap belt at the fourth anchor location. The fourth anchor location is intermediate of the second anchor location and the third anchor location. Each of the first anchor and the second anchor includes a belt loop through which the lap belt can be threaded. The first and second anchors and the lap belt cooperate to restrict lateral movement of a child seated in a center position when the lap belt is threaded through the first and second anchors. Lateral movement of a child seated in an off-center position can be restricted by routing the lap belt through only of the first and second anchors.

Additional features of the invention will become apparent to those skilled in the art upon consideration of the following detailed description of illustrative embodiments exemplifying the best mode of carrying out the invention as presently perceived.

### BRIEF DESCRIPTION OF THE DRAWINGS

The detailed description particularly refers to the accompanying figures in which:

FIG. 1 is a perspective view of a carriage for transporting one or more children showing the carriage including a restraint system;

FIG. 2 is a front elevation view of the carriage of FIG. 1, with portions broken away, showing the restraint system configured in a first arrangement wherein a lap belt is threaded through a left anchor and threaded through a right anchor;

FIG. 3 is a sectional view taken along line 3-3 of FIG. 2 showing the lap belt positioned between the right anchor and the seat;

FIG. 4 is a front elevation view of the carriage of FIG. 1, with portions broken away, showing the restraint system configured in a second arrangement wherein the lap belt is threaded through the left anchor but not the right anchor; and

FIG. 5 is a front elevation view of the carriage of FIG. 1, with portions broken away, showing the restraint system configured in a third arrangement wherein the lap belt is free from the left and right anchors.

### DETAILED DESCRIPTION OF THE DRAWINGS

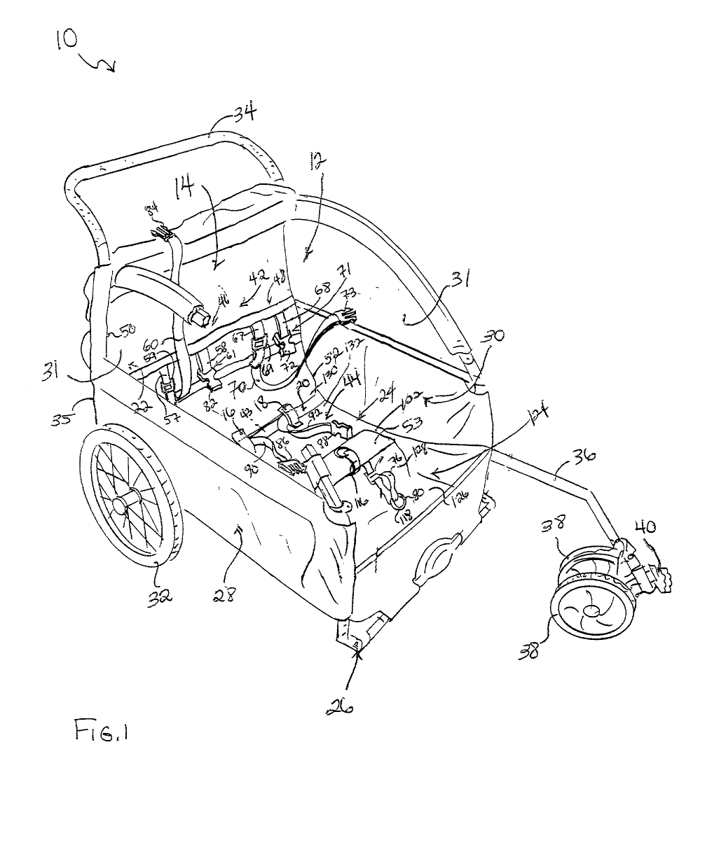

A carriage 10 for carrying one or more children therein is shown, for example, in FIG. 1. In one mode of operation, carriage 10 can be hitched to a bicycle, for example, to tow children therein behind the bicycle. In this mode, carriage 10 is operable as a bicycle trailer. In another mode of operation, carriage 10 can be unhitched from the bicycle so that carriage 10 is operable as a stroller to transport children apart from the bicycle.

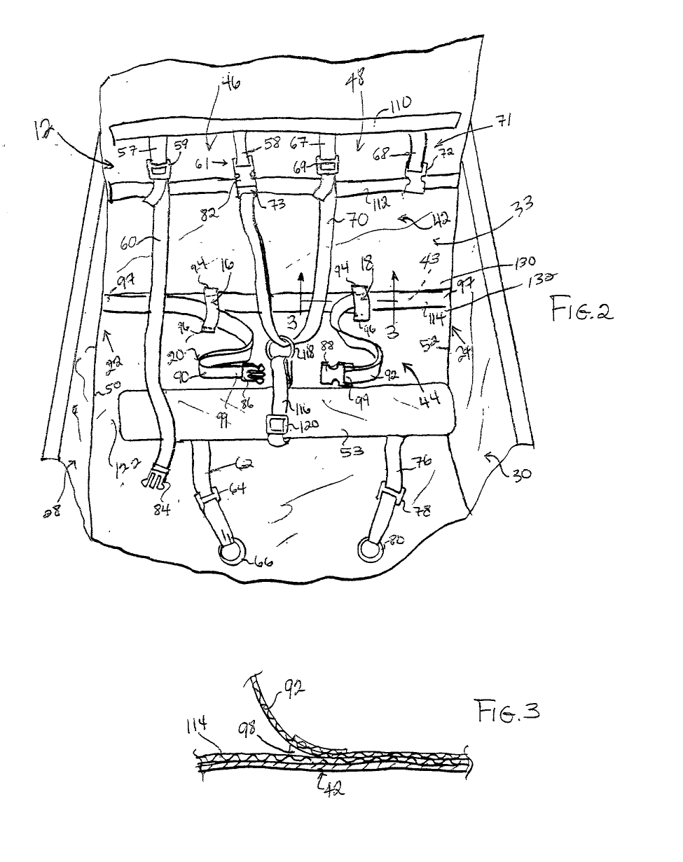

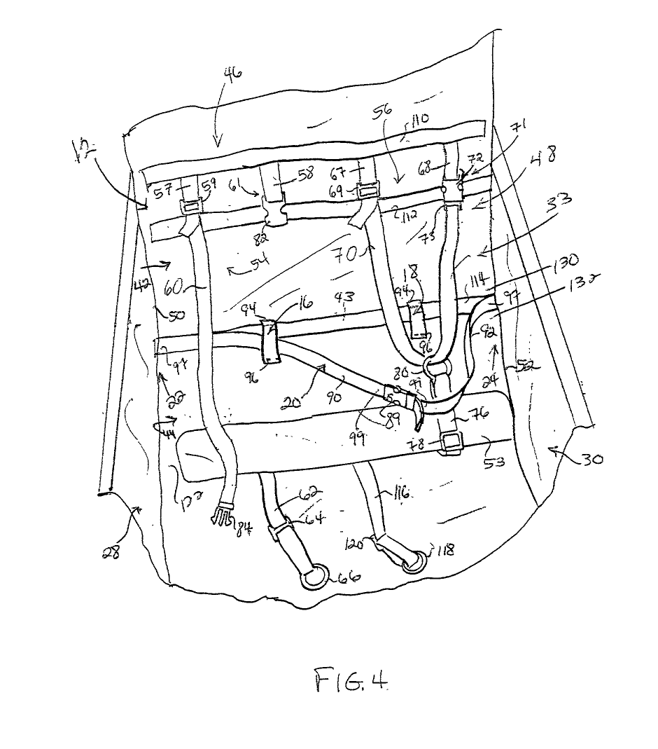

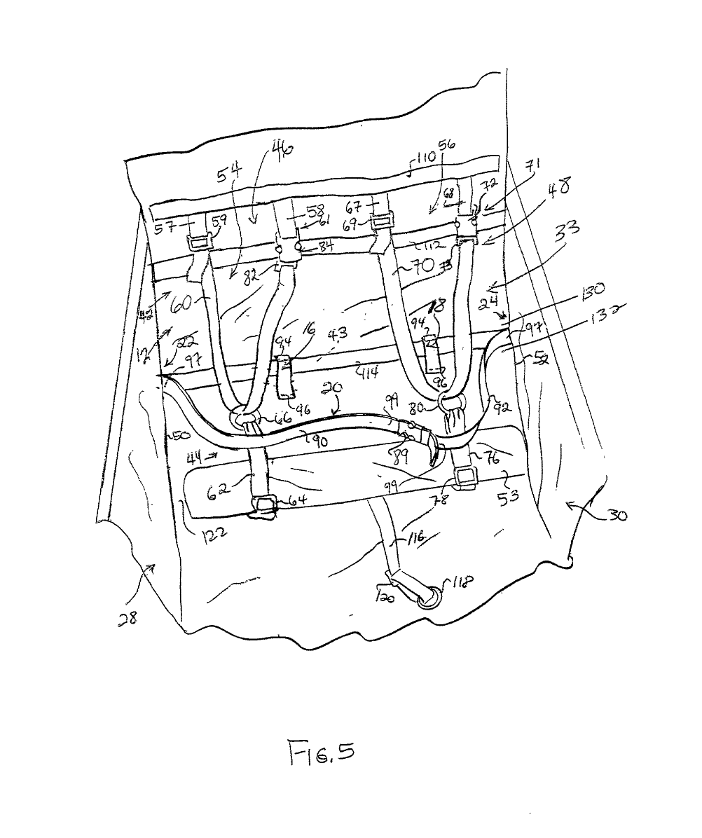

Carriage 10 includes a restraint system 12 for restraining the children in carriage 10 when carriage 10 is operated as either a trailer or a stroller. Restraint system 12 can be configured in a first arrangement (see FIGS. 1 and 2) to restrain one child in a seat 14 of carriage 10 at a center position, in a second arrangement (see FIG. 4) to restrain one child in seat 14 in an off-center position, or in a third arrangement (see FIG. 5) to restrain two children side-by-side in seat 14, as discussed in more detail below.

Restraint system 12 includes two lap belt anchors 16, 18 to anchor portions of a lap belt 20 to seat 14. Both anchors 16, 18 anchor lap belt 20 in the first arrangement, as illustrated, for example, in FIGS. 1 and 2, to restrain a center-seated child against lateral movement toward left and right sides 22, 24 of seat 14. Only one of anchors 16, 18 anchors lap belt 20 in the second arrangement, as illustrated, for example, in FIG. 4, to restrain a child against lateral movement. The second arrangement may be used to accommodate a relatively large child. Neither of anchors 16, 18 anchors lap belt 20 in the third arrangement, as illustrated, for example, in FIG. 5 in which two children are seated side-by-side in seat 14.

Seat 14 includes a frame 26 and a handle 34 for operating carriage 10 as a stroller, as illustrated, for example, in FIG. 1. Rear wheels 32 (only one shown) are coupled to frame 26. Front wheels 38 and a hitch 40 for coupling carriage 10 to a bicycle are coupled to a connector or pole 36 of frame 26. In some embodiments, in which carriage 10 is fashioned only as a stroller, pole 36, front wheels 38, and hitch 40 are omitted and one or more additional wheels are coupled to seat 14.

Seat 14 further includes a seat back 42, a seat bottom 44 coupled to seat back 42 at a junction 43, a left side wall 28, and a right side wall 30, as illustrated, for example, in FIG. 1. Left side wall 28 and the portions of seat back 42 and seat bottom 44 to the left of a longitudinal midline of seat 14 cooperate to define left side 22. Similarly, right side wall 30 and the portions of seat back 42 and seat bottom 44 to the right of the longitudinal midline cooperate to define right side 24. Seat back 42 and seat bottom 44 cooperate to define a child-seating surface 33. Seat 14 also includes a cushion 53 for the legs of children seated in seat 14.

Seat 14 also includes a lower leg-receiving portion 124, as illustrated, for example, in FIG. 1. Lower leg-receiving portion includes a calf-receiving wall 126 and a foot-receiving wall 128 coupled to calf-receiving wall 126. Calf-receiving wall 126 is coupled a front portion 122 of seat bottom 44.

Seat back 42 and seat bottom 44 are coupled to wall 28 along a left side edge 50 and to wall 30 along a right side edge 52, as illustrated, for example, in FIG. 2. Each of side walls 28, 30 includes a window 31, shown in FIG. 1, made of transparent material.

Restraint system 12 includes a left restraint 46 and a right restraint 48, as illustrated, for example, in FIGS. 1, 2, 4, and 5. Left restraint 46 includes a left shoulder harness 54 for a child seated on left side 22 and right restraint 48 includes a right shoulder harness 56 for a child seated on right side 24. Left shoulder harness 54 includes a height adjustment mechanism including a first height adjustment strap 57 and a second height adjustment strap 58, an adjuster 59, a left shoulder strap 60, and a two-piece buckle 61 including a female buckle member 82 and a male buckle member 84 sized to fit within female buckle member 82. Second height adjustment strap 58 and female buckle member 82 cooperate to define a left shoulder strap anchor 61, which, illustratively, takes the form of a strap.

Similarly, right shoulder harness 56 includes a height adjustment mechanism including a first height adjustment strap 67 and a second height adjustment strap 68, an adjuster 69, a left shoulder strap 70, and a two-piece buckle including a female buckle member 72 and a male buckle member 74 sized to fit within female buckle member 72. Second height adjustment strap 68 and female buckle member 72 cooperate to define a right shoulder strap anchor 71, which, illustratively, also takes the form of a strap.

Left and right shoulder harnesses 54, 56 are similar to one another so that the following description of left shoulder harness 54 applies also to right shoulder harness 56, except as otherwise noted. Both ends of height adjustment straps 57, 58 are coupled to seat back 42 by stitching, for example. Top and bottom ends of height adjustment straps 57, 58 are also stitched to a horizontal top reinforcer strap 110 and a horizontal intermediate reinforcer strap 112, respectively.

Adjuster 59 is, for example, a one-piece buckle having three slots. First height adjustment strap 57 extends through one of the slots so that adjuster 59 is free to move vertically along first height adjustment strap 57 to accommodate varying shoulder heights of children that may ride in carriage 10. At the same time, first height adjustment strap 57, for the most part, prevents adjuster 59 from moving horizontally.

Shoulder strap 60 extends through the other two slots of adjuster 59. In this way, the effective length of shoulder strap 60 can be adjusted by sliding shoulder strap 60 back and forth accordingly through adjuster 59 to adjust how tight shoulder strap 60 is positioned across the shoulders of a child. Shoulder strap 60 is also coupled to male buckle member 84.

Female buckle member 82 is formed to include a slot through which second height adjustment strap 59 extends. Thus, female buckle member 82, like adjuster 59, is free to move vertically along second height adjustment strap 58 to accommodate varying shoulder heights of children that may ride in carriage 10. At the same time, second adjustment strap 58, for the most part, prevents female buckle member 82 from moving horizontally.

Left restraint 46 further includes a left crotch strap 62 including an end fixed to front portion 122 of seat bottom 44, a left crotch strap adjuster 64 for adjusting the effective length of left crotch strap 62, and a left connector 66 coupled to the other end of left crotch strap 62 for connecting left shoulder strap 60 to left crotch strap 62, as illustrated, for example, in FIGS. 2, 4, and 5.

Right restraint 48 further includes a right crotch strap 76 including an end fixed to front portion 122, a right crotch strap adjuster 78 for adjusting the effective length of right crotch strap 76, and a right connector 80 coupled to the other end of right crotch strap 76 for connecting right shoulder strap 70 to right crotch strap 76, as illustrated, for example, in FIGS. 1, 2, 4, and 5.

Lap belt 20 includes a left strap portion 90 and a right strap portion 92, as illustrated, for example, in FIGS. 1, 2, 4, and 5. Each portion 90, 92 includes an outer end 97 and an inner end 99. Outer end 97 of left portion 90 is fixed to left side edge 50. Outer end 97 of right portion 92 is fixed to right side edge 52. Inner end 99 of left portion 90 is coupled to a male buckle member 86 of a buckle 89 of lap belt 20. Inner end 99 of right portion 92 is coupled to a female buckle member 88 of buckle 89.

Each of lap belt anchors 16, 18 is coupled to seat back 42 and seat bottom 44 so as to form an open belt loop that spans junction 43, as illustrated, for example, in FIGS. 1, 2, 4, and 5. Left anchor 16 is coupled to left side 22 of child-seating surface 33 of seat 14. Left anchor 16 is positioned between left side edge 50 and the longitudinal midline of seat 14. Right anchor 18 is coupled to right side 24 of child-seating surface 33 of seat 14. Right anchor 18 is positioned between right side edge 52 and the longitudinal midline of seat 14. Anchors 16, 18 are generally parallel to one another and extend longitudinally relative to seat 14. Each anchor 16, 18 cooperates with seat 16 to define a strap-receiving aperture 98 sized to receive one of portions 90, 92 of lap belt 20.

In the illustrated embodiment, each lap belt anchor 16, 18 includes a strap forming an open loop. Alternatively, each lap belt anchor 16, 18 includes a strap, a strip of fabric, or a piece of woven rope that is coupled to seat 14, by stitching for example, and forms a closed loop with itself to anchor lap belt 20. The strap, the strip of fabric, or piece of woven rope may be coupled to itself by stitching or by something like a button, a snap, or a hook-and-loop fastener, for example. In other alternative embodiments, each lap belt anchor 16, 18 includes a molded plastic loop in the form of a D-ring or a circular ring, for example, anchored to seat 14 by a tether, such as a strap. In yet other alternative embodiments, each lap belt anchor 16, 18 includes a clip that may be open- or closed-ended.

Each of anchors 16, 18 includes an upper end 94 and a lower end 96, as illustrated, for example, in FIGS. 2, 4, and 5. Upper end 94 is stitched with thread to a bottom portion 130 of seat back 42 and a horizontal bottom reinforcer strap. Lower end 96 is stitched with thread to a rear portion 132 of seat bottom 44. Rear portion 132 is spaced apart from front portion 122 of seat bottom 44. Bottom portion 130 and rear portion 132 cooperate to define junction 43.

Reinforcer straps 110, 112, 114 are configured to reinforce the material of seat 14. They are parallel to one another, as illustrated, for example, in FIGS. 2, 4, and 5.

Restraint system 12 also includes an intermediate crotch strap 116, as illustrated, for example, in FIGS. 1, 2, 4, and 5. Intermediate crotch strap 116 includes an end fixed to the front portion 122 of seat bottom 44. A connector 118 is coupled to the other end of intermediate crotch strap 116. An adjuster 120 is coupled to intermediate crotch strap 116 to adjust the effective length thereof. Intermediate crotch strap 116 is positioned between left crotch strap 62 and right crotch strap 76 along the longitudinal midline of seat 14.

The first arrangement of restraint system 12, as illustrated, for example, in FIG. 2, is configured to accommodate a single child seated in the center of seat 14. In the first arrangement, a child is seated on seat bottom 44 between left anchor 16 and right anchor 18 and crotch strap 116 extends upwardly from seat bottom 44 between the legs of the child. Right shoulder strap 70 extends through connector 118 and male buckle member 73 is coupled to female buckle member 82 so that right shoulder strap 70 is positioned across the shoulders of the child. Thus, right shoulder strap 70 is coupled to left shoulder strap anchor 61 and to intermediate crotch strap via connector 118 to restrain the child in seat 14.

Lap belt 20 is positioned across the lap of the child. Male and female buckle members 86, 88 of buckle 89 are coupled to one another. Left portion 90 of lap belt 20 extends through strap-receiving aperture 98 defined in part by left anchor 16. Right portion 92 of lap belt 20 extends through strap-receiving aperture 98 defined in part by right anchor 18. Thus, anchors 16, 18 operate to anchor lap belt 20 at two locations closer to the center-seated child than left and right side edges 50, 52 where lap belt 20 is also anchored. This restricts lateral movement of the child toward side walls 28, 30.

The second arrangement of restraint system 12, illustrated, for example, in FIG. 4, is configured to accommodate a single child in a first off-center position. The second arrangement may be suitable for a relatively large child, for example. In this arrangement, a child is seated on seat bottom 44 between left anchor 16 and right side edge 52. Right shoulder strap 70 is routed through right connector 80 and male buckle member 73 is coupled to female buckle member 72 so that right shoulder strap is positioned across the shoulders of the child. Thus, right shoulder strap 70 is coupled to right shoulder strap anchor 71 and to right crotch strap 76 via right connector 80 to restrain the child in seat 14.

Lap belt 20 is positioned across the lap of the child in the second arrangement. Male and female buckle members 86, 88 of buckle 89 are coupled to one another. Left portion 90 of lap belt 20 is threaded through strap-receiving aperture 98 defined in part by left anchor 16. Right portion 92 of lap belt 20 is not routed through strap-receiving aperture 98 defined in part by right anchor 18. Thus, left anchor 16 restricts lateral movement of the child toward left side wall 28.

Alternatively, left restraint 46 can be used instead of right restraint 48 in the second arrangement when the child is in a second off-center position. In this case, left shoulder strap 60 is coupled to left shoulder strap anchor 61 and to left crotch strap 62 via left connector 66 to restrain the seated child. Right portion 92 of lap belt 20 extends through strap-receiving aperture 98 defined in part by right anchor 18 whereas left portion 90 of lap belt 20 does not extend through the other strap-receiving aperture 98. In this way, right anchor 18 restricts lateral movement of the child toward right side wall 30.

The third arrangement of restraint system 12, as illustrated, for example, in FIG. 5, is configured to accommodate two children seated side-by-side one another in seat 14. In this arrangement, a first child is seated on left side 22 and a second child is seated on right side 24. Lap belt 20 extends across the laps of both children without passing through either strap-receiving aperture 98. Left shoulder strap 60 extends through left connector 66 and male buckle member 84 is coupled to female buckle member 82 so that left shoulder strap 60 is positioned across the shoulders of the first child. Thus, left shoulder strap 60 is coupled to left shoulder strap anchor 61 and to left crotch strap 62 via left connector 66 to restrain the first child in seat 14

Right shoulder strap 70 extends through right connector 80 and male buckle member 73 is coupled to female buckle member 72 so that right shoulder strap 70 is positioned across the shoulders of the second child. Thus, right shoulder strap 70 is coupled to right shoulder strap anchor 71 and to right crotch strap 76 via right connector 80 to restrain the second child in seat 14.

Lap belt 20 may be positioned to lie either in front of crotch straps 62, 76, 116, as shown, for example, in FIGS. 4 and 5, or behind crotch straps 62, 76, 116. Lap belt 20 may also be routed through an aperture defined by respective crotch strap 62, 76, 116.

Although the invention has been disclosed in detail with reference to certain illustrative embodiments, variations and modifications exist within the scope and spirit of the invention as described and defined in the following claims.

What is claimed is:

1. A carriage for transporting at least one child, the carriage comprising
a seat configured to support at least two side-by-side children,
a plurality of wheels coupled to the seat,
a restraint system including a lap belt and a first anchor, the lap belt being coupled to the seat at a first anchor location and a second anchor location, the first anchor being coupled to the seat at a third anchor location intermediate of the first anchor location and the second anchor location, the first anchor being configured to anchor the lap belt at the third anchor location.

2. The carriage of claim 1, wherein the seat includes a seat back and a seat bottom coupled to the seat back, the seat back includes a top portion and a bottom portion spaced apart from the top portion, the seat bottom includes a front portion and a rear portion spaced apart from the front portion and coupled to the bottom portion, and the first anchor is coupled to at least one of the bottom portion and the rear portion.

3. The carriage of claim 2, wherein the first anchor includes a belt loop including a first end coupled to the bottom portion and a second end coupled to the rear portion.

4. The carriage of claim 1, wherein the first anchor and the seat cooperate to define an aperture and the lap belt is arranged to extend through the aperture.

5. The carriage of claim 1, wherein the seat includes a child-seating surface configured to receive the at least two side-by-side children and the first anchor is coupled to the child-seating surface.

6. The carriage of claim 1, further comprising a second anchor coupled to the seat at a fourth anchor location intermediate of the second anchor location and the third anchor location and being configured to anchor the lap belt at the fourth anchor location.

7. The carriage of claim 6, wherein each of the first anchor and the second anchor includes a belt loop that cooperates with the seat to define an aperture and the lap belt is arranged to extend through both apertures.

8. A carriage for transporting at least one child, the carriage comprising
a seat configured to support at least two side-by-side children,
a plurality of wheels coupled to the seat, and
a restraint system including a shoulder restraint coupled to the seat, a crotch strap coupled to the seat, a lap belt coupled to the seat at a first anchor location and at a second anchor location, and a first anchor coupled to the seat at a third anchor location intermediate of the first anchor location and the second anchor location and configured to anchor the lap belt at the third anchor location.

9. The carriage of claim 8, wherein the first anchor includes a belt loop coupled to the seat.

10. The carriage of claim 9, wherein the first anchor and the seat cooperate to define an aperture and the lap belt is configured to extend through the aperture.

11. The carriage of claim 8, wherein the seat includes a child-seating surface adapted to receive the two side-by-side children therein and the first anchor is coupled to the child-seating surface.

12. The carriage of claim 8, further comprising a second anchor coupled to the seat at a fourth anchor location intermediate of the second anchor location and the third anchor location and configured to anchor the lap belt at the fourth anchor location.

13. The carriage of claim 12, wherein each of the first anchor and the second anchor includes a belt loop through which the lap belt can extend.

14. The carriage of claim 12, wherein the seat includes a seat back and a seat bottom coupled to the seat back, each of the first anchor and the second anchor includes a first end and a second end, the first ends are coupled to the seat back, and the second ends are coupled to the seat bottom.

15. A carriage for transporting at least one child, the carriage comprising
a seat including a seat back and a seat bottom coupled to the seat back, the seat back and the seat bottom cooperating to define a left side edge, a right side edge, and a child-seating surface adapted to receive a child therein,
a plurality of wheels coupled to the seat,
a left restraint,
a right restraint, each of the left restraint and the right restraint including a shoulder strap coupled to the seat back, a shoulder strap anchor coupled to the seat back, and a crotch strap coupled to the seat bottom,
an intermediate crotch strap coupled to the seat bottom between the crotch strap of the left restraint and the crotch strap of the right restraint,
a lap belt coupled to the left side edge and the right side edge,
a left belt loop coupled to the child-seating surface between the left side edge and the right side edge, and
a right belt loop coupled to the child-seating surface of the seat between the left belt loop and the right side edge of the seat, wherein, in a first arrangement, the lap belt is adapted to extend across laps of a first child and a second child seated side-by-side one another, the shoulder strap of the left restraint is coupled to the shoulder strap anchor of the left restraint and the crotch strap of the left restraint so that the lap belt and the left restraint are adapted to restrain the first child, and the shoulder strap of the right restraint is coupled to the shoulder strap anchor of the right restraint and the crotch strap of the right restraint so that the lap belt and the right restraint are adapted to restrain the second child, and, in a second arrangement, the shoulder strap of one of the left restraint and the right restraint is coupled to the shoulder strap anchor of the other of the left restraint and the right restraint and to the intermediate crotch strap, the lap belt is adapted to extend across a lap of a single child seated in the seat, a left portion of the lap belt extends through the left belt loop, and a right portion of the lap belt extends through the right belt loop to restrain the single child.

16. The carriage of claim 15, wherein the left belt loop cooperates with the child-seating surface to define a left aperture, the right belt loop cooperates with the child-seating surface to define a right aperture, the left portion of the lap belt extends through the left aperture in the second arrangement, and the right portion of the lap belt extends through the right aperture in the second arrangement.

17. The carriage of claim 15, wherein the seat back includes a top portion and a bottom portion spaced apart from the top portion, the seat bottom includes a front portion and a rear portion spaced apart from the front portion and coupled to the bottom portion, each of the left belt loop and the right belt loop is coupled to the bottom portion and the rear portion.

18. The carriage of claim 15, wherein the left belt loop is positioned between a longitudinal midline of the seat and the left side edge and the right belt loop is positioned between the longitudinal midline and the right side edge.

19. A carriage for transporting at least one child, the carriage comprising
a seat configured to support at least two side-by-side children,
a plurality of wheels coupled to the seat, and
a restraint system including a lap belt coupled to the seat, a first anchor coupled to the seat, and a second anchor coupled to the seat, the lap belt being spaced apart from the first and second anchors when two children are supported by the seat, and the lap belt being threaded through the first anchor and spaced apart from the second anchor when one child is supported by the seat in an off-center position, and the lap belt being threaded through the first and second anchors when one child is supported by the seat in a center position.

20. The carriage of claim 19, wherein each of the first anchor and the second anchor includes a belt loop.

21. The carriage of claim 20, wherein the seat includes a seat back and a seat bottom coupled to the seat back and each belt loop includes a first end coupled to the seat back and a second end coupled to the seat bottom.

22. The carriage of claim 19, wherein the lap belt is coupled to the seat at a first anchor location and at a second anchor location, the first anchor is coupled to the seat at a third anchor location, the second anchor is coupled to the seat at a fourth anchor location, the third anchor location and the fourth anchor location are positioned intermediate of the first anchor location and the second anchor location.
